(19) United States
(12) Patent Application Publication
(10) Pub. No.: US 2020/0190998 A1
(43) Pub. Date: Jun. 18, 2020

(54) TURBINE BLADE WITH A COUPLED SERPENTINE CHANNEL

(71) Applicant: Solar Turbines Incorporated, San Diego, CA (US)

(72) Inventors: Hongzhou Xu, San Diego, CA (US); Kevin Liu, San Diego, CA (US); Michael D. Fox, San Diego, CA (US)

(73) Assignee: Solar Turbines Incorporated, San Diego, CA (US)

(21) Appl. No.: 16/217,953

(22) Filed: Dec. 12, 2018

(51) Int. Cl. F01D 5/18; F01D 5/14; F01D 5/30

(52) U.S. Cl. CPC F01D 5/188; F01D 5/141; F01D 5/3015; F05D 2220/32; F05D 2260/232; F05D 2260/22141; F05D 2260/205

(57) ABSTRACT

A turbine blade having a base and an airfoil, the base including a root end. The airfoil including a skin extending from the base and defining a first edge, a second edge, having a tip end opposite from the root end. The turbine blade further including a base rib extending from the base and into the airfoil, a center divider extending from adjacent the first edge towards the second edge, a center rib disposed between the center divider and the second edge, extending from adjacent the center divider towards the tip end and extending from adjacent the center divider towards the root end, a tip center rib extending from adjacent the second edge towards the first edge, a tip rib extending from adjacent the tip center rib towards the base, a dividing rib and a first channel.

### TECHNICAL FIELD

The present disclosure generally pertains to gas turbine engines. More particularly this application is directed toward a turbine blade with a coupled serpentine channel

### BACKGROUND

Internally cooled turbine blades may include passages within the blade. These hollow blades may be cast. In casting hollow gas turbine engine blades having internal cooling passageways, a fired ceramic core is positioned in a ceramic investment shell mold to form internal cooling passageways in the cast airfoil. The fired ceramic core used in investment casting of hollow airfoils typically has an airfoil-shaped region with a thin cross-section leading edge region and trailing edge region. Between the leading and trailing edge regions, the core may include elongated and other shaped openings so as to form multiple internal walls, pedestals, turbulators, ribs, and similar features separating and/or residing in cooling passageways in the cast airfoil.

U.S. Pat. No. 8,118,553 to George Liang, describes a cooling system for a turbine airfoil of a turbine engine having dual serpentine cooling channels, an inward serpentine cooling channel and an outward serpentine cooling channel, positioned within the airfoil. The inward serpentine cooling channel may receive cooling fluids from a cooling supply system through the root and exhaust cooling fluids to the outward serpentine cooling channel at the leading edge. The outward serpentine cooling channel may pass the cooling fluids through the outward portion of the serpentine cooling channel and exhaust the cooling fluids through the trailing edge of the airfoil. Such configuration yields a better creep capability for the blade.

The present disclosure is directed toward overcoming one or more of the problems discovered by the inventors.

### SUMMARY

A turbine blade for a gas turbine engine is disclosed herein. In embodiments the turbine blade includes a base and an airfoil. The base includes a root end and the airfoil includes a skin extending from the base and defining a first edge, a second edge opposite the first edge, a pressure side, and a lift side opposite the pressure side, and having a tip end opposite from the root end.

The airfoil further includes a base rib, a center divider, a center rib, a tip center rib, a tip rib, a tip wall, and a dividing rib. The base rib disposed within the airfoil and the base, extending from the base and into the airfoil, and having a base rib end disposed opposite from the base. The center divider extending from adjacent the first edge towards the second edge, disposed between the base rib and the tip end. The center rib disposed between the center divider and the second edge, extending from adjacent the center divider towards the tip end and extending from adjacent the center divider towards the root end, the center rib disposed between the root end and the tip end and at least partially between the base rib and the second edge. The center rib having a center rib tip end disposed at the tip end of the center rib, and a center rib base end disposed opposite from the tip end. The tip center rib extending from adjacent the second edge towards the first edge, disposed between the center rib and the tip end. The tip rib extending from adjacent the tip center rib, distal to the second edge, towards the base, the tip rib disposed at least partially between the center rib and the first edge, disposed between the center divider and the tip end, and having a tip rib end disposed opposite from the tip end. The dividing rib extending from a dividing rib base end proximate an interface of the airfoil and the base, towards the tip end while between the first edge and the base rib, to between the tip rib and the first edge and between the tip end and the center divider. The dividing rib having a dividing rib tip end disposed proximate and spaced from the tip end.

The turbine blade further includes a first channel beginning between the dividing rib base end and the first edge. The first channel extending to the center divider while between the first edge and the dividing rib. The first channel further extends around the base rib tip, between the dividing rib and the center divider, and further to between the dividing rib and the center rib. The first channel further extends toward the root end while located between the dividing rib and the center rib. The first channel further extends around the center rib base end while between the center rib and the dividing rib, towards the tip end while between the center rib and the dividing rib. The first channel further extends towards the tip end while between the center rib and the dividing rib. The first channel further extends around the center rib tip end while between the center rib and dividing rib, towards the base while between the dividing rib and the center rib. The first channel further extends to the center divider while between the dividing rib and center rib. The first channel further extends around the tip rib end while between the dividing rib and the center divider, to between the dividing rib and the first edge. The first channel further extends towards the tip end, between the first edge and the dividing rib, to between the dividing rib and the tip wall.

### BRIEF DESCRIPTION OF THE FIGURES

The details of embodiments of the present disclosure, both as to their structure and operation, may be gleaned in part by study of the accompanying drawings, in which like reference numerals refer to like parts, and in which:

FIG. 1 is a schematic illustration of an exemplary gas turbine engine;

FIG. 2 is an axial view of an exemplary turbine rotor assembly;

FIG. 3 is an isometric view of one turbine blade of FIG. 2;

FIG. 4 is a cutaway side view of the turbine blade of FIG. 3;

FIG. 5 is a cross section of the cooled turbine blade taken along the line 5-5 of FIG. 4;

FIG. 6 is a cross section of the cooled turbine blade taken along the line 6-6 of FIG. 4; and

FIG. 7 is a cutaway side view of an another embodiment of the turbine blade of FIG. 3;

### DETAILED DESCRIPTION

The detailed description set forth below, in connection with the accompanying drawings, is intended as a description of various embodiments and is not intended to represent the only embodiments in which the disclosure may be practiced. The detailed description includes specific details for the purpose of providing a thorough understanding of the embodiments. However, it will be apparent to those skilled in the art that the disclosure without these specific details. In some instances, well-known structures and components are shown in simplified form for brevity of description.

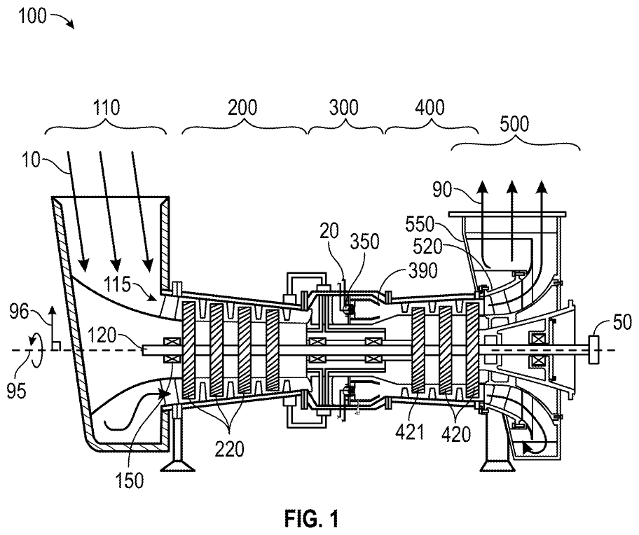

FIG. 1 is a schematic illustration of an exemplary gas turbine engine. Some of the surfaces have been left out or exaggerated for clarity and ease of explanation. Also, the disclosure may reference a forward and an aft direction. Generally, all references to “forward” and “aft” are associated with the flow direction of primary air (i.e., air used in the combustion process), unless specified otherwise. For example, forward is “upstream” relative to primary air flow, and aft is “downstream” relative to primary air flow.

In addition, the disclosure may generally reference a center axis 95 of rotation of the gas turbine engine, which may be generally defined by the longitudinal axis of its shaft 120 (supported by a plurality of bearing assemblies 150). The center axis 95 may be common to or shared with various other engine concentric components. All references to radial, axial, and circumferential directions and measures refer to center axis 95, unless specified otherwise, and terms such as “inner” and “outer” generally indicate a lesser or greater radial distance from, wherein a radial 96 may be in any direction perpendicular and radiating outward from center axis 95.

A gas turbine engine 100 includes an inlet 110, a gas producer or “compressor” 200, a combustor 300, a turbine 400, an exhaust 500, and a power output coupling 50. The compressor 200 includes one or more compressor rotor assemblies 220. The combustor 300 includes one or more injectors 350 and includes one or more combustion chambers 390. The turbine 400 includes one or more turbine rotor assemblies 420. The exhaust 500 includes an exhaust diffuser 520 and an exhaust collector 550.

As illustrated, both compressor rotor assembly 220 and turbine rotor assembly 420 are axial flow rotor assemblies, where each rotor assembly includes a rotor disk that is circumferentially populated with a plurality of airfoils (“rotor blades”). When installed, the rotor blades associated with one rotor disk are axially separated from the rotor blades associated with an adjacent disk by stationary vanes (“stator vanes” or “stators”) circumferentially distributed in an annular casing.

A gas (typically air 10) enters the inlet 110 as a “working fluid”, and is compressed by the compressor 200. In the compressor 200, the working fluid is compressed in an annular flow path 115 by the series of compressor rotor assemblies 220. In particular, the air 10 is compressed in numbered “stages”, the stages being associated with each compressor rotor assembly 220. For example, “4th stage air” may be associated with the 4th compressor rotor assembly 220 in the downstream or “aft” direction—going from the inlet 110 towards the exhaust 500). Likewise, each turbine rotor assembly 420 may be associated with a numbered stage. For example, first stage turbine rotor assembly 421 is the forward most of the turbine rotor assemblies 420. However, other numbering/naming conventions may also be used.

Once compressed air 10 leaves the compressor 200, it enters the combustor 300, where it is diffused and fuel 20 is added. Air 10 and fuel 20 are injected into the combustion chamber 390 via injector 350 and ignited. After the combustion reaction, energy is then extracted from the combusted fuel/air mixture via the turbine 400 by each stage of the series of turbine rotor assemblies 420. Exhaust gas 90 may then be diffused in exhaust diffuser 520 and collected, redirected, and exit the system via an exhaust collector 550. Exhaust gas 90 may also be further processed (e.g., to reduce harmful emissions, and/or to recover heat from the exhaust gas 90).

One or more of the above components (or their subcomponents) may be made from stainless steel and/or durable, high temperature materials known as “superalloys”. A superalloy, or high-performance alloy, is an alloy that exhibits excellent mechanical strength and creep resistance at high temperatures, good surface stability, and corrosion and oxidation resistance. Superalloys may include materials such as HASTELLOY, INCONEL, WASPALOY, RENE alloys, HAYNES alloys, INCOLOY, MP98T, TMS alloys, and CMSX single crystal alloys.

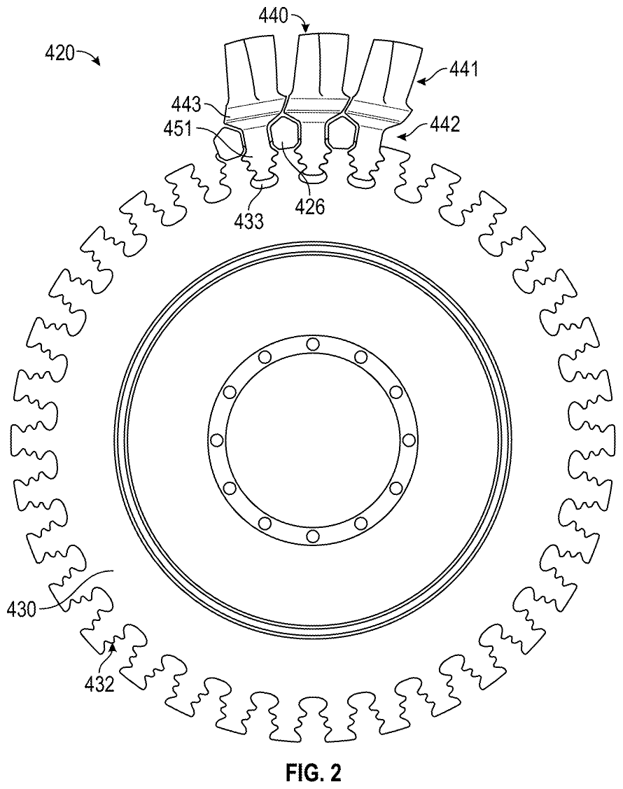

FIG. 2 is an axial view of an exemplary turbine rotor assembly. In particular, the turbine rotor assembly 420 schematically illustrated in FIG. 1 is shown here in greater detail, but in isolation from the rest of gas turbine engine 100. The turbine rotor assembly 420 includes a turbine rotor disk 430 that is circumferentially populated with a plurality of turbine blades configured to receive cooling air (“cooled turbine blades” 440) and a plurality of dampers 426. Here, for illustration purposes, turbine rotor disk 430 is shown depopulated of all but three cooled turbine blades 440 and three dampers 426.

Each cooled turbine blade 440 may include a base 442 including a platform 443 and a blade root 451. For example, the blade root 451 may incorporate “fir tree”, “bulb”, or “dove tail” roots, to list a few. Correspondingly, the turbine rotor disk 430 may include a plurality of circumferentially distributed slots or “blade attachment grooves” 432 configured to receive and retain each cooled turbine blade 440. In particular, the blade attachment grooves 432 may be configured to mate with the blade root 451, both having a reciprocal shape with each other. In addition the blade attachment grooves 432 may be slideably engaged with the blade attachment grooves 432, for example, in a forward-to-aft direction.

Being proximate the combustor 300 (FIG. 1), the turbine rotor assembly 420 may incorporate active cooling. In particular, compressed cooling air may be internally supplied to each cooled turbine blade 440 as well as predetermined portions of the turbine rotor disk 430. For example, here turbine rotor disk 430 engages the cooled turbine blade 440 such that a cooling air cavity 433 is formed between the blade attachment grooves 432 and the blade root 451. In other embodiments, other stages of the turbine may incorporate active cooling as well.

When a pair of cooled turbine blades 440 is mounted in adjacent blade attachment grooves 432 of turbine rotor disk 430, an under-platform cavity may be formed above the circumferential outer edge of turbine rotor disk 430, between shanks of adjacent blade roots 451, and below their adjacent platforms 443, respectively. As such, each damper 426 may be configured to fit this under-platform cavity. Alternately, where the platforms are flush with circumferential outer edge of turbine rotor disk 430, and/or the under-platform cavity is sufficiently small, the damper 426 may be omitted entirely.

Here, as illustrated, each damper 426 may be configured to constrain received cooling air such that a positive pressure may be created within the under-platform cavity to suppress the ingress of hot gases from the turbine. Additionally, damper 426 may be further configured to regulate the flow of cooling air to components downstream of the turbine rotor assembly 420. For example, damper 426 may include one or more aft plate apertures in its aft face. Certain features of the illustration may be simplified and/or differ from a production part for clarity.

Each damper 426 may be configured to be assembled with the turbine rotor disk 430 during assembly of the turbine rotor assembly 420, for example, by a press fit. In addition, the damper 426 may form at least a partial seal with the adjacent cooled turbine blades 440. Furthermore, one or more axial faces of damper 426 may be sized to provide sufficient clearance to permit each cooled turbine blade 440 to slide into the blade attachment grooves 432, past the damper 426 without interference after installation of the damper 426.

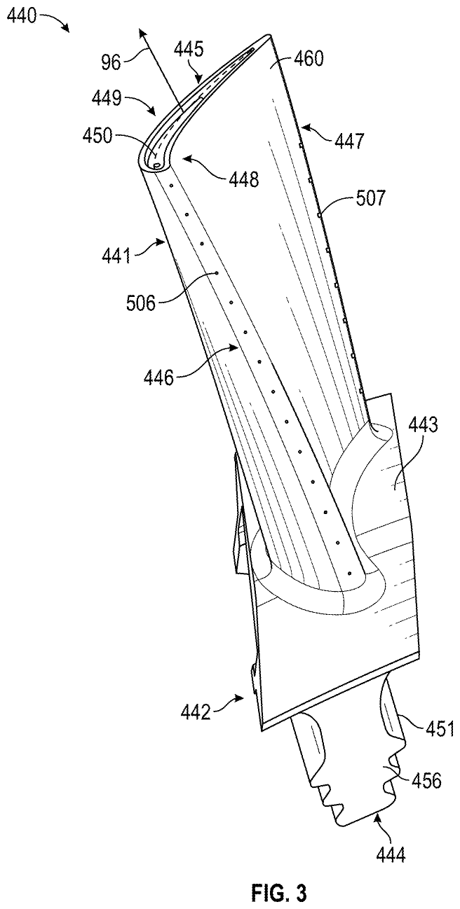

FIG. 3 is a perspective view of the turbine blade of FIG. 2. As described above, the cooled turbine blade 440 may include a base 442 having a platform 443, a blade root 451, and a root end 444. Each cooled turbine blade 440 may further include an airfoil 441 extending radially outward from the platform 443. The airfoil 441 may have a complex, geometry that varies radially. For example the cross section of the airfoil 441 may lengthen, thicken, twist, and/or change shape as it radially approaches the platform 443 inward from a tip end 445. The overall shape of airfoil 441 may also vary from application to application.

The cooled turbine blade 440 is generally described herein with reference to its installation and operation. In particular, the cooled turbine blade 440 is described with reference to both a radial 96 of center axis 95 (FIG. 1) and the aerodynamic features of the airfoil 441. The aerodynamic features of the airfoil 441 include a leading edge 446, a trailing edge 447, a pressure side 448, a lift side 449, and its mean camber line 450. The leading edge 446 and the trailing edge 447, either one of which can be referred to a first edge or a second edge. The leading edge 446 may have leading edge holes 506 and trailing edge 447 may have trailing edge slots 507 that can permit cooling air 15 to exit the turbine blade 440. The mean camber line 450 is generally defined as the line running along the center of the airfoil from the leading edge 446 to the trailing edge 447. It can be thought of as the average of the pressure side 448 and lift side 449 of the airfoil 441 shape. As discussed above, airfoil 441 also extends radially between the platform 443 and the tip end 445. Accordingly, the mean camber line 450 herein includes the entire camber sheet continuing from the platform 443 to the tip end 445.

Thus, when describing the cooled turbine blade 440 as a unit, the inward direction is generally radially inward toward the center axis 95 (FIG. 1), with its associated end called a “root end” 444. Likewise the outward direction is generally radially outward from the center axis 95 (FIG. 1), with its associated end called the “tip end” 445. When describing the platform 443, the forward face 456 and the aft face 457 of the platform 443 is associated to the forward and aft axial directions of the center axis 95 (FIG. 1), as described above. The base 442 can further include a forward face 456 and an aft face 457. The forward face 456 corresponds to the face of the base 442 that is disposed on the forward end of the base 442. The aft face 457 corresponds to the face of the base 442 that is disposed distal from the forward face 456.

In addition, when describing the airfoil 441, the forward and aft directions are generally measured between its leading edge 446 (forward) and its trailing edge 447 (aft), along the mean camber line 450 (artificially treating the mean camber line 450 as linear). When describing the flow features of the airfoil 441, the inward and outward directions are generally measured in the radial direction relative to the center axis 95 (FIG. 1). However, when describing the thermodynamic features of the airfoil 441 the inward and outward directions are generally measured in a plane perpendicular to a radial 96 of center axis 95 (FIG. 1) with inward being toward the mean camber line 450 and outward being toward the “skin” 460 of the airfoil 441.

Finally, certain traditional aerodynamics terms may be used from time to time herein for clarity, but without being limiting. For example, while it will be discussed that the airfoil 441 (along with the entire cooled turbine blade 440) may be made as a single metal casting, the outer surface of the airfoil 441 (along with its thickness) is descriptively called herein the “skin” 460 of the airfoil 441. In another example, each of the ribs described herein can act as a wall or a divider.

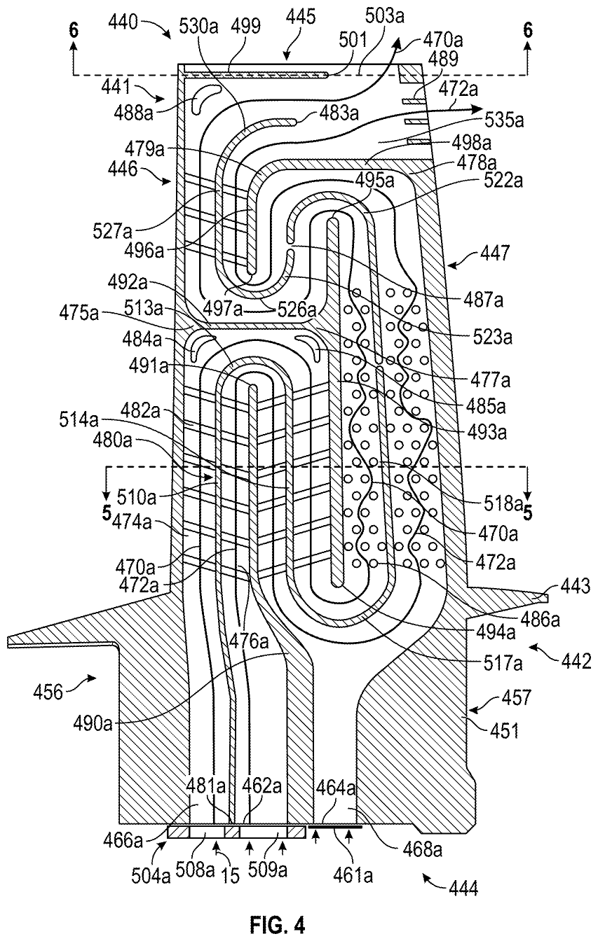

FIG. 4 is a cutaway side view of the turbine blade of FIG. 3. In particular, the cooled turbine blade 440 of FIG. 3 is shown here with the skin 460 removed from the pressure side 448 of the airfoil 441, exposing its internal structure and cooling paths. The airfoil 441 may include a composite flow path made up of multiple subdivisions and cooling structures. Similarly, a section of the base 442 has been removed to expose portions of a main inlet passage 466a and a secondary inlet passage 468a internal to the base 442. The turbine blade 440 shown in FIG. 4 generally depicts the features visible from the pressure side 448. The leading edge holes 506 and the trailing edge slots 507 have not been shown in FIG. 4.

The cooled turbine blade 440 includes an airfoil 441 and a base 442. The base 442 may include the platform 443, the blade root 451, the forward face 456, the aft face 457, the root end 444, a main inlet 462a, and a secondary inlet 464a. The airfoil 441 interfaces with the base 442 and may include the skin 460, a tip wall 499, a dividing rib 480a, a tip opening 503a, and a trailing edge outlet 489a.

Compressed secondary air 15 may be routed into the main inlet 462a and secondary inlet 464a in the base 442 of cooled turbine blade 440 as cooling air 15. The main inlet 462a and secondary inlet 464a may be at any convenient location. For example, here, the main inlet 462a and secondary inlet 464a are located in the blade root 451. Alternately, cooling air 15 may be received in a shank area radially outward from the blade root 451 but radially inward from the platform 443. The main inlet 462a may be disposed between the forward face 456 and the secondary inlet 464a. The main inlet 462a is configured to allow compressed cooling air 15 into the turbine blade 440. The secondary inlet may be disposed between the main inlet 462a and the aft face 457. In an embodiment, a blocking plate 461a may be disposed radially inward of the secondary inlet 464a and can restrict the cooling air 15 from entering the secondary inlet 464a. In some embodiments the secondary inlet 464a is present to aid in casting the cooled turbine blade 440.

Within the base 442, the cooled turbine blade 440 includes the main inlet passage 466a configured to route cooling air 15 from the main inlet 462a, through the base 442, and into the airfoil 441 via the first channel 474a and the second channel 476a. The base 442 may also include a secondary inlet passage 468a that is configured to route cooling air 15 from the secondary inlet 464a, through the base 442 and into the airfoil 441 via the second channel 476a. The main inlet passage 466a and secondary inlet passage 468a may be configured to translate the cooling air 15 in three dimensions (e.g., not merely in the plane of the figure) as it travels radially up (e.g., generally along a radial 96 of the center axis 95 (FIG. 1)) towards the airfoil 441 and along a first multi-bend heat exchange path 470a and a second multi-bend heat exchange path 472a. For example, the cooling air 15 can travel radially and within the airfoil 441. The first multi-bend heat exchange path 470a and the second multi-bend heat exchange path 472a are depicted as solid lines drawn as a weaving path through the airfoil 441, exiting through the airfoil 441 and ending with an arrow. The first multi-bend heat exchange path 470a may be an air flow path confined or substantially confined by the first channel 474a and the second multi-bend heat exchange path 472a may be an air flow path confined or substantially confined by the second channel 476a.

Within the skin 460 of the airfoil 441 and the base 442 of the turbine blade, several internal structures are viewable. In particular, the turbine blade 440 includes a base rib 490a, a center divider 492a, a center rib 493a, a tip rib 496a, a tip center rib 498a, and a dividing rib 480a. Several of the internal structures, such as the base rib 490a, the center divider 492a, the center rib 493a, the tip rib 496a, the tip center rib 498a, and the dividing rib 480a, may remain continuous or include gaps. In addition, the airfoil 441 may include a tip wall 499, turbulators 482a, a first edge air deflector 484a, a center air deflector 485a, a tip air deflector 488a, cooling fins 486a, a trailing edge outlet 489a, and a tip opening 503a.

In an embodiment, the base rib 490a is disposed within the airfoil 441 and the base 442 and extends from the base 442 and up into the airfoil 441. In other words, the base rib 490a can be disposed between the main inlet passage 466a and the secondary inlet passage 468a and extend from the root end 444 towards the tip end 445. The base rib 490a can bend towards the leading edge 446 when located proximate to the interface of the airfoil 441 and the base 442. The base rib 490a can extend from the pressure side 448 of the skin 460 to the lift side 449 of the skin 460. The base rib 490a may be located between the main inlet 462a and the secondary inlet 464a. The base rib 490a can be wider adjacent the root end 444 than opposite from the root end 444. The base rib 490a may include a base rib end 491a disposed opposite from the base 442. The base rib end 491a may be disposed closer to the leading edge 446 than the base rib 490a proximate the root end 444.

In an embodiment, the center divider 492a extends from leading edge 446 towards the trailing edge 447. The center divider 492a is disposed between the base rib 490a and the tip end 445. Further, the center divider 492a can be disposed between the base rib 490a and the tip rib 496a. The center divider 492a can extend from the pressure side 448 of the skin 460 to the lift side 449 of the skin 460. The center divider 492a can have a center divider transition 475a that extends from the center divider 492a to the leading edge 446 and is wider adjacent the leading edge 446 than opposite the leading edge 446. The center divider transition 475a may be shaped as a double fillet tee joint joining the center divider 492a to the leading edge 446. The center divider 492a may have a center rib transition 477a that is disposed opposite from the center divider transition 475a. The center rib transition 477a may extend from the center divider 492a to the center rib 493a and be wider adjacent the center rib 493a than opposite the center rib 493a. The center rib transition 477a may be shaped as a double fillet tee joint joining the center divider 492a to the center rib 493a.

The center rib 493a is disposed between the center divider 492a and the trailing edge 447. The center rib 493a extends from adjacent the center divider 492a towards the tip end 445 and extends from adjacent the center divider 492a towards the root end 444. The center rib 493a is also disposed between the root end 444 and the tip end 445. In an embodiment, the center rib 493a may be disposed between the base 442 and the tip center rib 498a and can adjoin the center rib transition 477a. The center rib can extend 493a from the center divider 492a to proximate to the interface of where the airfoil 441 extends from the base 442. The center rib 493a can extend from the pressure side 448 of the skin 460 to the lift side 449 of the skin 460. The center rib 493a may a have a cross-section shaped as an elongated stadium. The center rib 493a may include a center rib tip end 495a disposed at the tip end 445 of the center rib 493a and a center rib base end 494a disposed opposite from the tip end 445.

The tip center rib 498a extends from the trailing edge 447 towards the leading edge 446 and is disposed between the center rib 493a and the tip end 445. The tip center rib 498a may extend from the pressure side 448 of the skin 460 to the lift side 449 of the skin 460. The tip center rib 498a can include a tip center rib transition 478a that extends from the tip center rib 498a to the trailing edge 447 and be wider adjacent to the trailing edge 447 than opposite the trailing edge 447. The tip center rib transition 478a may be shaped as a fillet joining the tip center rib 498a to the trailing edge 447. The tip center rib 498a may include a tip rib transition 479a that is disposed opposite from the tip center rib transition 478a that extends from the tip center rib 498a towards the base 442. The tip rib transition 479a may be shaped as a fixed radial transition joining the tip center rib 498a to the tip rib 496a.

The tip rib 496a extends from the tip center rib 498a towards the base 442 and is disposed between the center rib 493a and the leading edge 446. The tip rib 496a is also disposed between the center divider 492a and the tip end 445. The tip rib 496a may extend from the tip rib transition 479a towards the base 442. The tip rib 496a may extend from the pressure side 448 of the skin to the lift side 449 of the skin 460. The tip rib 496a may in include a tip rib end 497a disposed opposite from the tip end 445.

The tip wall 499 may extend from the leading edge 446 towards the trailing edge 447 and disposed proximate the tip end 445. The tip wall 499 may extend from the pressure side 448 of the skin 460 to the lift side 449 of the skin 460. The tip wall 499 may be disposed between the tip end 445 and the tip center rib 498a. In other words the tip wall 499 may be disposed between the tip end 445 and the tip rib 496a. The tip wall 499 may be recessed inward such that it is not flush with the tip of the airfoil 441. The tip wall 499 may include a tip wall end 501 disposed opposite from the leading edge 446.

The tip opening 503a is defined by the space between the pressure side 448 of the skin 460, the lift side 449 of the skin, the tip wall 499, and the trailing edge 447. The tip opening 503a allows for cooling air 15 to escape the airfoil 441 through the tip end 445.

The trailing edge outlet 489a extends through the trailing edge 447 and is disposed proximate the tip end 445. The trailing edge outlet 489a allows for cooling air 15 to escape the airfoil 441 through the trailing edge 447.

The dividing rib 480a extends throughout the turbine blade 440 in a serpentine configuration. The dividing rib 480a can extend from adjacent the main inlet 462a to between the leading edge 446 and the base rib 490a. In an alternative embodiment the dividing rib 480a can extend from proximate to the interface of the airfoil 441 and the base 442, to between the leading edge 446 and the base rib 490a, and further to between the leading edge 446 and tip rib 496a. In other words the dividing rib can extend from proximate the base 442. The dividing rib 480a may have several portions including a dividing rib lower first edge portion 510a, a dividing rib lower first edge transition portion 513a, a dividing rib lower middle portion 514a, a dividing rib lower middle transition portion 517a, a dividing rib second edge portion 518a, a dividing rib second edge transition portion 522a, a dividing rib upper middle portion 523a, a dividing rib upper middle transition portion 526a, a dividing rib upper first edge portion 527a, and a dividing rib upper first edge transition portion 530a. The dividing rib 480a may extend from the pressure side 448 of the skin 460 to the lift side 449 of the skin 460. In an embodiment, the dividing rib 480a may have dividing rib gaps 487a disposed along the dividing rib 480a. Alternatively, the dividing rib 480a may remain continuous. The dividing rib 480a may also include a dividing rib tip end 483a disposed proximate and spaced from the tip end 445.

The dividing rib 480a may include a dividing rib base end 481a disposed opposite from the dividing rib tip end 483a. The dividing rib base end 481a can be disposed proximate and spaced from the leading edge 446, proximate to where the base 442 and airfoil 441 meet. The dividing rib 480a can be configured to divide the cooling air 15 into a first channel 474a and a second channel 476a. The airfoil 441 may include a tip end channel 535 that may begin proximate to the dividing rib tip end 483a and where the first channel 474a and the second channel 476a combine. The tip end channel 535 may be defined by the dividing rib tip end 483a, the tip center rib 498a, trailing edge 447, tip wall 499, the pressure side 448 of the skin 460, and the lift side 449 of the skin 460.

In an embodiment, the dividing rib lower first edge portion 510a can extend from adjacent the main inlet 462a and root end towards the tip end 445 while between the leading edge 446 and the base rib 490a. In an alternative embodiment, the dividing rib lower first edge portion 510a can extend from proximate to the interface of the airfoil 441 and the base 442 towards the tip end 445 while between the leading edge 446 and the base rib 490a. In other words, the dividing rib lower first edge portion 510a can extend from proximate the base 442 towards the center divider 492a. In other words, the dividing rib lower middle portion 514a can extend from proximate to the interface of the airfoil 441 and the base 442 to proximate the base rib end 491a.

The dividing rib lower first edge transition portion 513a can extend from the dividing rib lower first edge portion 510a, from between the leading edge 446 and the base rib 490a, around the base rib end 491a, to between the base rib 490a and the center divider 492a, and further to between the base rib 490a and the center rib 493a. The dividing rib lower first edge transition portion 513a may have a cross-section shaped as an annulus sector.

The dividing rib lower middle portion 514a can extend from the dividing rib lower first edge transition portion 513a towards the root end 444 while located between the base rib 490a and the center rib 493a. In other words, the dividing rib lower middle portion 514a can extend from proximate the base rib end 491a to proximate the center rib base end 494a. The dividing rib lower middle portion is disposed between the center divider 492a and the root end 444.

The dividing rib lower middle transition portion 517a can extend from the dividing rib lower middle portion 514a, from between the base rib 490a and the center rib 493a, around the center rib 493a base end 494a, to between the center rib 493a and the base rib 490a, and further to between the center rib 493a and the trailing edge 447. The dividing rib lower middle transition portion 517a may have a cross-section shaped as an annulus sector.

The dividing rib second edge portion 518a can extend from the dividing rib lower middle transition portion 517a towards the tip end 445 while between the center rib 493a and the trailing edge 447. In other words, the dividing rib second edge portion 518a can extend from proximate the center rib base end 494a to proximate the center rib tip end 495a. The dividing rib second edge portion 518a is disposed between the root end 444 and the tip center rib 498a.

The dividing rib second edge transition portion 522a can extend from the dividing rib second edge portion 518a, from between the trailing edge 447 and the center rib 493a, around the center rib tip end 495a, to between the center rib 493a and the tip center rib 498a, and further to between the tip rib 496a and the center rib 493a. The dividing rib second edge transition portion 522a may have a cross-section shaped as an annulus sector.

The dividing rib upper middle portion 523a can extend from the dividing rib second edge transition portion 522a towards the center divider 492a while between the tip rib 496a and center rib 493a. In other words, the dividing rib upper middle portion 523a can extend from proximate the center rib tip end 495a to proximate the tip rib end 497a. The dividing rib upper middle portion 523a is disposed between the tip end 445 and the center divider 492a.

The dividing rib upper middle transition portion 526a can extend from the dividing rib upper middle portion 523a, from between the tip rib 496a and the center rib 493a, around the tip rib end 497a, to between the tip rib 496a and the center divider 492a, and further to between the tip rib 496a and the leading edge 446. The dividing rib upper middle transition portion 526a may have a cross-section shaped as an annulus sector.

The dividing rib upper first edge portion 527a can extend from the dividing rib upper middle transition portion 526a towards the tip end 445, between the leading edge 446 and the tip rib 496a. In other words, the dividing rib upper first edge portion 527a can extend from proximate the tip rib end 497a towards the tip wall 499. The dividing rib upper first edge portion 527a is disposed between the center divider 492a and tip wall 499.

The dividing rib upper first edge transition portion 530a can extend from the dividing rib upper first edge portion 527a towards the tip end 445, from between the leading edge 446 and tip rib 496a, around the tip rib transition 479a, to between the tip end 445 and the tip center rib 498a. Together with the skin 460, the dividing rib 480a and other described structures, may form the first channel 474a and first multi-bend heat exchange path 470a along with the second channel 476 the second multi-bend heat exchange path 472a within the airfoil 441.

The first channel 474a may extend throughout the turbine blade 440 in a serpentine configuration similar to and partially defined by the dividing rib 480a and can be formed by the dividing rib 480a, the skin 460, and other internal structures in the airfoil 441. The first channel 474a can be in flow communication with the main inlet passage 466a and main inlet 462a. The first channel 474a can begin between the forward face 456 and the dividing rib 480a and disposed adjacent the main inlet 462a. Alternatively, the first channel 474a can begin between the dividing rib base end 481a and the leading edge 446. The first channel 474a can extend to the center divider 492a while between the leading edge 446 and the dividing rib 480a. The first channel 474a can continue extending around the base rib end 491a, between the dividing rib 480a and the center divider 492a, and further to between the dividing rib 480a and the center rib 493a. The first channel 474a can then extend toward the root end 444 while located between the dividing rib 480a and the center rib 493a. The first channel 474a can further extend around the center rib base end 494a while between the center rib 493a and the dividing rib 480a, and towards the tip end 445 while between the center rib 493a and the dividing rib 480a. The first channel 474a can continue by extending towards the tip end 445 while between the center rib 493a and the dividing rib 480a. The first channel 474a can further continue by extending around the center rib tip end 495a while between the center rib 493a and dividing rib 480a, towards the base 442 while between the dividing rib 480a and the center rib 493a. The first channel 474a can continue by extending to the center divider 492a while between the dividing rib and center rib 493a. The first channel 474a can continue by extending around the tip rib end 497a while between the dividing rib and the center divider 492a, to between the dividing rib 480a and the leading edge 446. The first channel 474a can further continue by extending towards the tip end 445, between the leading edge 446 and the dividing rib 480a, to between the dividing rib 480a and the tip wall 499, and further to the tip end channel 535.

The second channel 476a may extend throughout the turbine blade 440 in a serpentine configuration similar to the first channel 474a and can be formed by the dividing rib 480a, the skin 460, and other internal structures in the airfoil 441. The second channel 476a may be in flow communication with the main inlet 462a and the main inlet passage 466a. The second channel 476a may be in flow communication with the secondary inlet 464a and the secondary inlet passage 468a. The second channel 476a can begin between the dividing rib 480a and the base rib 490a and disposed adjacent the main inlet 462a. Alternatively, the second channel 476a can begin between the dividing rib base end 481a and the base rib 490a. The second channel 476a can extend from between the dividing rib 480a and the base rib 490a to the center divider 492a. The second channel 476a can continue extending around the base rib end 491a, to between the base rib 490a and the dividing rib 480a, and further towards the base 442. The second channel 476a can then extend further towards the root end 444, while located between the base rib 490a and the dividing rib 480a. The second channel 476a can further extend around the center rib base end 494a between the dividing rib 480a and the root end 444, to between the dividing rib 480a and the trailing edge 447. The second channel 476a can continue by extending to the tip center rib 498a while between the dividing rib 480a and the trailing edge 447. The second channel 476a can further continue by extending around the center rib tip end 495a while between the dividing rib 480a and the tip center rib 498a, to between the tip rib 496a and the dividing rib 480a. The second channel 476a can continue by extending towards the center divider 492a while between the tip rib 496a and dividing rib 480a. The second channel 476a can continue by extending around the tip rib end 497a while between the tip rib 496a and the dividing rib 480a, towards the tip end 445. The second channel 476a can further continue by extending towards the tip end 445, between the dividing rib 480a and the tip rib 496a, to the tip end channel 535.

The internal structures making up the first multi-bend heat exchange path 470a and second multi-bend heat exchange path 472a may form multiple discrete sub-passageways. For example, although the first multi-bend heat exchange path 470a and the second multi-bend heat exchange path 472a are shown by a representative path of cooling air 15, multiple composite flow paths are possible.

The possible multiple composite flow paths may include additional features within the airfoil 441. These features may be turbulators 482a, cooling fins 486a, a first edge air deflector 484a, a center air deflector 485a, and a tip air deflector 488a.

In an embodiment, the turbulators 482a may be disposed between the leading edge 446 and the dividing rib 480a and between the dividing rib 480a and the base rib 490a. The turbulators 482a can be distributed throughout the other remaining areas of the airfoil 441 as well. The turbulators 482a can be formed as ridges on the skin 460 and can be operable to interrupt flow along the first channel 474a and second channel 476a and prevent formation of a boundary layer which can decrease cooling effects of the cooling air 15.

The cooling fins 486a may extend from the pressure side 448 of the skin 460 to the lift side 449 of the skin 460. In an embodiment the cooling fins are disposed between the center rib 493a and the trailing edge 447. The cooling fins 486a may be disbursed copiously throughout the airfoil 441 or in other selected locations. In particular, the cooling fins 486a may be disbursed throughout the airfoil 441 so as to thermally interact with the cooling air 15 for increased cooling. The distribution may be regular, irregular, staggered, and/or localized. According to one embodiment, one or more of the cooling fins 486a may be pin fins or pedestals. The pin fins or pedestals may include many different cross-sectional areas, such as: circular, oval, racetrack, square, rectangular, diamond cross-sections, just to mention only a few. As discussed above, the pin fins or pedestals may be arranged as a staggered array, a linear array, or an irregular array.

The airfoil 441 may include several air deflectors including a first edge air deflector 484a, a center air deflector 485a, and a tip air deflector 488a that may extend from the pressure side 448 of the skin 460 to the lift side 449 of the skin. The first edge air deflector 484a, center air deflector 485a, and tip air deflector 488a can also have an aerodynamic shape having a chord length to width ratio of approximately 2:1 to 3:1 ratio. The first edge air deflector 484a can be disposed proximate to the center divider 492a and the leading edge 446. In other words, the first edge air deflector 484a can be disposed proximate to the center divider transition 475a. The center air deflector 485a can be disposed proximate to the center divider 492a and the center rib 493a. In other words, the center air deflector 485a can be disposed proximate to the center rib transition 477a. The tip air deflector 488a can be disposed proximate to the leading edge 446 and the tip wall 499. The first edge air deflector 484a, center air deflector 485a, and tip air deflector 488a can have sizes and positions selected to maximize cooling in their respective locations. The first edge air deflector 484a, center air deflector 485a, and tip air deflector 488a may be configured to redirect cooling air 15 flowing through the first channel 474a. The size, arrangement, shape of the first edge air deflector 484a, center air deflector 485a, and tip air deflector 488a are selected to optimize cooling effectiveness of the cooling air 15 and increase fatigue life of the cooled turbine blade 440. This can reduce the presence of dead spots, leading to more uniform cooling for the cooled turbine blade 440.

The turbine blade 440 may further include a metering plate 504a. The metering plate 504a can be disposed adjacent to and radially inward of the main inlet 462a with respect to the central axis 95. The metering plate 504a may extend from the adjacent the base rib 490a towards the forward face 456. The metering plate 504a may include a first metering orifice 508a and a second metering orifice 509a. In an embodiment, the second metering orifice 509a is disposed proximate to the dividing rib 480a and the base rib 490a, and is in flow communication with the second channel 476a. The size of the second metering orifice 509a can be selected to provide a desired amount or flow of cooling air 15 to the second channel 476a. In an embodiment, the first metering orifice 508a is disposed between the second metering orifice 509a and the forward face 456. The size of the first metering orifice 509a can selected to provide a desired amount or flow of cooling air 15 to the first channel 474a.

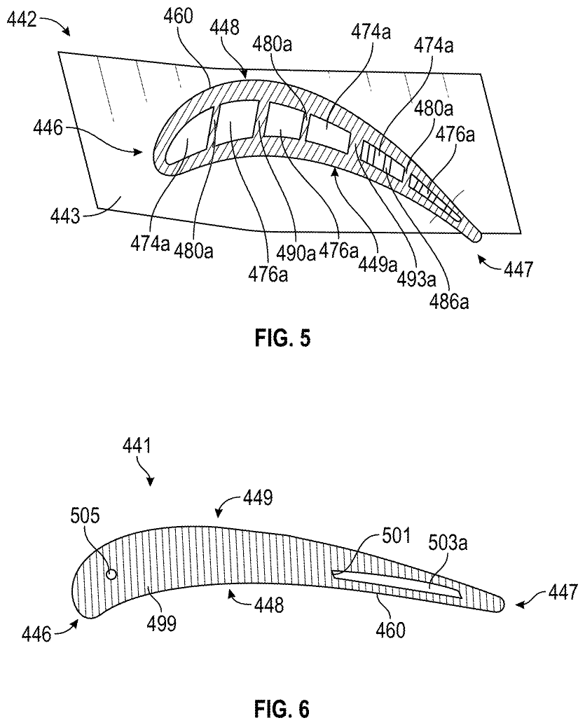

FIG. 5 is a cross section of the cooled turbine blade taken along the line 5-5 of FIG. 4. In an embodiment, the airfoil 441 can have a skin 460 that encompasses multiple structural elements. In an embodiment, the first channel 474a can be disposed between the leading edge 446 and the dividing rib 480a, as well as between the center rib 493a and the dividing rib 480a. The second channel 476a can be disposed between the dividing rib 480a and the base rib 490a, as well as between the trailing edge 447 and the dividing rib 480a.

FIG. 6 is a cross section of the cooled turbine blade taken along the line 6-6 of FIG. 4. In an embodiment, the airfoil 441 can have a skin 460 that encompasses multiple structural elements. In an embodiment, the tip wall 499 can have a tip end vent 505 that is configured such that a small quantity of the cooling air 15 may be bled off for film cooling near the tip end 445. The airfoil 441 may also include a tip opening 503a that is defined by the space between the pressure side 448 of the skin 460, the lift side 449 of the skin, the tip wall 499, and the trailing edge 447. The tip opening 503a operable to allow for cooling air 15 to escape the airfoil 441 near the tip end 445.

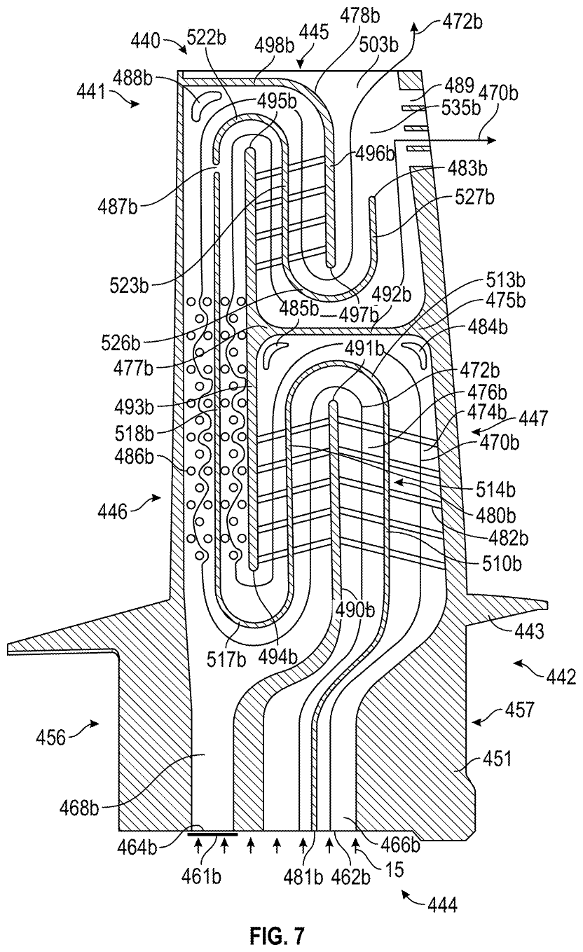

FIG. 7 is a cutaway side view of another embodiment of the turbine blade of FIG. 3. Structures and features previously described in connection with earlier described embodiments may not be repeated here with the understanding that when appropriate, that previous description applies to the embodiment depicted in FIG. 7. Additionally, the emphasis in the following description is on variations of previously introduced feature or elements. Also, some reference numbers for previously descripted features are omitted. In particular, another embodiment of the cooled turbine blade 440 of FIG. 3 is shown here with the skin 460 removed from the pressure side 448 of the airfoil 441, exposing its internal structure and cooling paths. The airfoil 441 may include a composite flow path made up of multiple subdivisions and cooling structures Similarly, a section of the base 442 has been removed to expose portions of a main inlet passage 466b and a secondary inlet passage 468b internal to the base 442. The turbine blade 440 shown in FIG. 7 generally depicts the features visible from the pressure side 448.

In an embodiment, the base rib 490b can bend towards the trailing edge 447 when located proximate to the interface of where the airfoil 441 extends from the base 442. The base rib end 491b may be disposed closer to the trailing edge 447 than the base rib 490b proximate the root end 444.

In an embodiment, the center divider 492b extends from trailing edge 447 towards the leading edge 446. The center divider 492b can have a center divider transition 475b that extends from the center divider 492b to the trailing edge 447 and is wider adjacent the trailing edge 447 than opposite the trailing edge 447. The center divider transition 475b may be shaped as a double fillet tee joint joining the center divider 492b to the trailing edge 447.

The center rib 493b is disposed between the center divider 492b and the leading edge 446.

The tip center rib 498b extends from the leading edge 446 towards the trailing edge 447 and is disposed between the center rib 493b and the tip end 445. The tip center rib 498b can include a tip center rib transition 478b that extends from the tip center rib 498b to the leading edge 446 and be wider adjacent to the leading edge 446 than opposite the leading edge 446. The tip center rib transition 478b may be shaped as a fillet joining the tip center rib 498b to the leading edge 446.

The tip rib 496b extends from the tip center rib 498b towards the base 442 and is disposed between the center rib 493b and the trailing edge 447.

The tip opening 503b is defined by the space between the pressure side 448 of the skin 460, the lift side 449 of the skin, the tip center rib 498b, and the trailing edge 447. The tip opening 503b allows for cooling air 15 to escape the airfoil 441 through the tip end 445.

The dividing rib 480b extends throughout the turbine blade 440 in a serpentine configuration. The dividing rib 480b can extend from adjacent the main inlet 462b to between the trailing edge 447 and the base rib 490b. In an alternative embodiment the dividing rib 480b can extend from proximate to the interface of the airfoil 441 and the base 442, to between the trailing edge 447 and the base rib 490b, and further to between the leading edge 446 and tip rib 496b. In other words the dividing rib can extend from proximate the base 442. The dividing rib 480b may have several portions including a dividing rib lower first edge portion 510b, a dividing rib lower first edge transition portion 513b, a dividing rib lower middle portion 514b, a dividing rib lower middle transition portion 517b, a dividing rib second edge portion 518b, a dividing rib second edge transition portion 522b, a dividing rib upper middle portion 523b, a dividing rib upper middle transition portion 526b, a dividing rib upper first edge portion 527b, a dividing rib upper first edge transition portion 530b, and a dividing rib tip end portion 531b. The dividing rib 480b may extend from the pressure side 448 of the skin 460 to the lift side 449 of the skin 460. In an embodiment, the dividing rib 480b may have dividing rib gaps 487b disposed along the dividing rib 480b. Alternatively, the dividing rib 480b may remain continuous. The dividing rib 480b may also include a dividing rib tip end 483b disposed proximate and spaced from the tip end 445.

The dividing rib 480b may include a dividing rib base end 481b disposed opposite from the dividing rip tip end 485b. The dividing rib base end 481b can be disposed proximate and spaced from the trailing edge 447, proximate to where the base 442 and airfoil 441 meet. The dividing rib 480b can be configured to divide the cooling air 15 into a first channel 474b and a second channel 476b. The airfoil 441 may include a tip end channel 535 that may begin proximate to the dividing rib tip end 483b and where the first channel 474b and the second channel 476b combine. The tip end channel 535 may be defined by the dividing rib tip end 483b, the tip center rib 498b, trailing edge 447, the tip rib 496b, the pressure side 448 of the skin 460, and the lift side 449 of the skin 460.

In an embodiment, the dividing rib lower first edge portion 510b can extend from adjacent the main inlet 462b and the root end 444 towards the tip end 445 while between the trailing edge 447 and the base rib 490b. In an alternative embodiment, the dividing rib lower first edge portion 510b can extend from proximate to the interface of the airfoil 441 and the base 442 towards the tip end 445 while between the trailing edge 447 and the base rib 490b. In other words, the dividing rib lower first edge portion 510b can extend from proximate the base 442 towards the center divider 492b. In other words, the dividing rib lower middle portion 514b can extend from proximate to the interface of the airfoil 441 and the base 442 to proximate the base rib end 491b.

The dividing rib lower first edge transition portion 513b can extend from the dividing rib lower first edge portion 510b, from between the trailing edge 447 and the base rib 490b, around the base rib end 491b, to between the base rib 490b and the center divider 492b, and further to between the base rib 490b and the center rib 493b.

The dividing rib lower middle portion 514b can extend from the dividing rib lower first edge transition portion 513b towards the root end 444 while located between the base rib 490b and the center rib 493b. In other words, the dividing rib lower middle portion 514b can extend from proximate the base rib end 491b to proximate the center rib base end 494b. The dividing rib lower middle portion is disposed between the center divider 492b and the root end 444.

The dividing rib lower middle transition portion 517b can extend from the dividing rib lower middle portion 514b, from between the base rib 490b and the center rib 493b, around the center rib 493b base end 494b, to between the center rib 493b and the base rib 490b, and further to between the center rib 493b and the leading edge 446.

The dividing rib second edge portion 518b can extend from the dividing rib lower middle transition portion 517b towards the tip end 445 while between the center rib 493b and the leading edge 446. In other words, the dividing rib second edge portion 518b can extend from proximate the center rib base end 494b to proximate the center rib tip end 495b. The dividing rib second edge portion 518b is disposed between the root end 444 and the tip center rib 498b.

The dividing rib second edge transition portion 522b can extend from the dividing rib second edge portion 518b, from between the leading edge 446 and the center rib 493b, around the center rib tip end 495b, to between the center rib 493b and the tip center rib 498b, and further to between the tip rib 496b and the center rib 493b.

The dividing rib upper middle portion 523b can extend from the dividing rib second edge transition portion 522b towards the center divider 492b while between the tip rib 496b and center rib 493b. In other words, the dividing rib upper middle portion 523b can extend from proximate the center rib tip end 495b to proximate the tip rib end 497b. The dividing rib upper middle portion 523b is disposed between the tip end 445 and the center divider 492b.

The dividing rib upper middle transition portion 526b can extend from the dividing rib upper middle portion 523b, from between the tip rib 496b and the center rib 493b, around the tip rib end 497b, to between the tip rib 496b and the center divider 492b, and further to between the tip rib 496b and the leading edge 446.

The dividing rib upper first edge portion 527b can extend from the dividing rib upper middle transition portion 526b towards the tip end 445, between the trailing edge 447 and the tip rib 496b. In other words, the dividing rib upper first edge portion 527b can extend from proximate the tip rib end 497b towards the tip end 445. The dividing rib upper first edge portion 527b is disposed between the center divider 492b and tip end 445.

The first channel 474b may extend throughout the turbine blade 440 in a serpentine configuration similar to the dividing rib 480b and be formed by the dividing rib 480b, the skin 460, and other internal structures in the airfoil 441. The first channel 474b can be in flow communication with the main inlet passage 466b and main inlet 462b. The first channel 474b can begin between the forward face 456 and the dividing rib 480b and disposed adjacent the main inlet 462b. Alternatively, the first channel 474b can begin between the dividing rib base end 481b and the trailing edge 447. The first channel 474b can extend to the center divider 492b while between the trailing edge 447 and the dividing rib 480b. The first channel 474b can continue extending around the base rib end 491b, between the dividing rib 480b and the center divider 492b, to between the dividing rib 480b and the center rib 493b. The first channel 474b can then extend toward the root end 444 while located between the dividing rib 480b and the center rib 493b. The first channel 474b can further extend around the center rib base end 494b between the center rib 493b and the dividing rib 480b, towards the tip end 445 while between the center rib 493b and the dividing rib. The first channel 474b can continue by extending towards the tip end 445 while between the center rib 493b and the dividing rib 480b. The first channel 474b can further continue by extending around the center rib tip end 495b while between the center rib 493b and dividing rib 480b, towards the base 442 while between the dividing rib 480b and the center rib 493b. The first channel 474b can continue by extending to the center divider 492b while between the dividing rib and center rib 493b. The first channel 474b can continue by extending around the tip rib end 497b while between the dividing rib and the center divider 492b, to between the dividing rib 480b and the trailing edge 447. The first channel 474b can further continue by extending towards the tip end 445, between the trailing edge 447 and the dividing rib 480b, and further to the tip end channel 535.

The second channel 476b may extend throughout the turbine blade 440 in a serpentine configuration similar to the first channel 474b and be formed by the dividing rib 480b, the skin 460, and other internal structures in the airfoil 441. The second channel 476b may be in flow communication with the main inlet 462b and the main inlet passage 466b. The second channel may be in flow communication with the secondary inlet 464b and the secondary inlet passage 468b. The second channel 476b can begin between the dividing rib 480b and the base rib 490b and disposed adjacent the main inlet 462b. Alternatively, the second channel 476b can begin between the dividing rib base end 481b and the base rib 490b. The second channel 476b can extend from between the dividing rib 480b and the base rib 490b to the center divider 492b. The second channel 476b can continue extending around the base rib end 491b, between the base rib 490b and the dividing rib 480b, towards the base 442. The second channel 476b can then extend further towards the root end 444, while located between the base rib and the dividing rib 480b. The second channel 476b can further extend around the center rib base end 494b between the dividing rib 480b and the root end 444, to between the dividing rib 480b and the leading edge 446. The second channel 476b can continue by extending to the tip center rib 498b while between the dividing rib 480b and the leading edge 446. The second channel 476b can further continue by extending around the center rib tip end 495b while between the dividing rib 480b and the tip center rib 498b, to between the tip rib 496b and the dividing rib 480b. The second channel 476b can continue by extending towards the center divider 492b while between the tip rib 496b and dividing rib 480b. The second channel 476b can continue by extending around the tip rib end 497b while between the tip rib 496b and the dividing rib 480b, towards the tip end 445. The second channel 476b can further continue by extending towards the tip end 445 and to the tip end channel 535.

In an embodiment, the turbulators 482b may be disposed between the trailing edge 447 and the dividing rib 480b and between the dividing rib 480b and the base rib 490b. The turbulators 482b can be distributed throughout the other remaining areas of the airfoil 441 as well.

The cooling fins 486b may extend from the pressure side 448 of the skin 460 to the lift side 449 of the skin 460. In an embodiment the cooling fins 486b are disposed between the center rib 493b and the leading edge 446. The cooling fins 486b may be disbursed copiously throughout the airfoil 441. In particular, the cooling fins 486b may be disbursed throughout the airfoil 441 so as to thermally interact with the cooling air 15 for increased cooling.

The airfoil 441 may include several air deflectors including a first edge air deflector 484b, a center air deflector 485b, and a tip air deflector 488b that may extend from the pressure side 448 of the skin 460 to the lift side 449 of the skin. The first edge air deflector 484b can be disposed proximate to the center divider 492b and the trailing edge 447. The tip air deflector 488b can be disposed proximate to the leading edge 446 and the tip center rib 498b. The first edge air deflector 484b, center air deflector 485b, and tip air deflector 488b can have sizes and positions selected to maximize cooling in their respective locations.

### INDUSTRIAL APPLICABILITY

The present disclosure generally applies to cooled turbine blades 440, and gas turbine engines 100 having cooled turbine blades 440. The described embodiments are not limited to use in conjunction with a particular type of gas turbine engine 100, but rather may be applied to stationary or motive gas turbine engines, or any variant thereof. Gas turbine engines, and thus their components, may be suited for any number of industrial applications, such as, but not limited to, various aspects of the oil and natural gas industry (including include transmission, gathering, storage, withdrawal, and lifting of oil and natural gas), power generation industry, cogeneration, aerospace and transportation industry, to name a few examples.

Generally, embodiments of the presently disclosed cooled turbine blades 440 are applicable to the use, assembly, manufacture, operation, maintenance, repair, and improvement of gas turbine engines 100, and may be used in order to improve performance and efficiency, decrease maintenance and repair, and/or lower costs. In addition, embodiments of the presently disclosed cooled turbine blades 440 may be applicable at any stage of the gas turbine engine's 100 life, from design to prototyping and first manufacture, and onward to end of life. Accordingly, the cooled turbine blades 440 may be used in a first product, as a retrofit or enhancement to existing gas turbine engine, as a preventative measure, or even in response to an event. This is particularly true as the presently disclosed cooled turbine blades 440 may conveniently include identical interfaces to be interchangeable with an earlier type of cooled turbine blades 440.

As discussed above, the entire cooled turbine blade 440 may be cast formed. According to one embodiment, the cooled turbine blade 440 may be made from an investment casting process. For example, the entire cooled turbine blade 440 may be cast from stainless steel and/or a superalloy using a ceramic core or fugitive pattern. Accordingly, the inclusion of the dividing rib 480a, 480b is amenable to the manufacturing process. Notably, while the structures/features have been described above as discrete members for clarity, as a single casting, the structures/features may be integrated with the skin 460. Alternately, certain structures/features may be added to a cast core, forming a composite structure.

Embodiments of the presently disclosed cooled turbine blades 440 provide for an increase in cooling capacity, which makes it more amenable to stationary gas turbine engine applications. In particular, serpentine configuration provides for improved cooling at lower spans of the airfoil and use the spent cooling air 15 from the lower span to continue and cool the upper span of the airfoil where the turbine blade 440 can tolerate higher metal temperatures.

In a disclosed embodiment, pressurized cooling air 15 is received by the base 442 of the airfoil 441. The cooling air 15 is received from the main inlet 462a, 462b and flows through the main inlet passage 466a, 466b in a generally radial direction. From the main inlet passage 466a, 466b, the cooling air 15 is received by the first channel 474a, 474b and the second channel 476a, 476b and may follow the first multi-bend heat exchange path 470a, 470b and the second multi-bend heat exchange path 472a, 472b respectively. A first turn of the first channel 474a, 474b and the second channel 476a, 476b around the base rib 490a, 492b provides increased cooling effects of the cooling air 15 as it passes through the lower span of the turbine blade 440.

The cooling air 15 generally follows the first channel 474a, 474b and the second channel 476a, 476b along the dividing rib 480a, 480b until the first channel 474a, 474b and second channel 476a, 476b approach the tip end 445 and combine into the tip end channel 535a, 535b. Once the cooling air 15 enters the tip end channel 535a, 535b the cooling air 15 is generally directed out of the trailing edge outlet 489a, 489b or the tip opening 503a, 503b.

The first multi-bend heat exchange path 470a, 470b and the second multi-bend heat exchange path 472a, 472b are configured such that cooling air 15 will pass between, along, and around the various internal structures, but generally flows in serpentine path as viewed from the side view from the base 442 back and forth toward and away from the tip end 445 (e.g., conceptually treating the camber sheet as a plane). Accordingly, the first multi-bend heat exchange path 470a, 470b and the second multi-bend heat exchange path 472a, 472b may include some negligible lateral travel (e.g., into and out of the plane) associated with the general curvature of the airfoil 441. Also, as discussed above, although the first multi-bend heat exchange path 470a, 470b and the second multi-bend heat exchange path 472a, 472b are illustrated by two single representative flow lines traveling through two sections for clarity, first multi-bend heat exchange path 470a, 470b and the second multi-bend heat exchange path 472a, 472b include the entire flow path carrying cooling air 15 through the airfoil 441. With the implementation of the dividing rib 480a, 480b, the first multi-bend heat exchange path 470a, 470b and the second multi-bend heat exchange path 472a, 472b make use of the serpentine flow path with more uniform temperature distribution in comparison to single bend turbine blades. This provides for a higher cooling efficiency at lower spans and helps break up possible dead zones.

In rugged environments, certain superalloys may be selected for their resistance to particular corrosive attack. However, depending on the thermal properties of the superalloy, greater cooling may be beneficial. The described method of manufacturing a cooled turbine blade 440 provides for implementing the dividing rib 480a, 480b. In particular, the dividing rib 480a, 480b creates two channels which achieve a more uniform temperature distribution of a turbine blade and increase cooling efficiency at lower airfoil spans and could increase blade life. Moreover, the internal airfoil structures including the dividing rib 480a, 480b can be suitable for use in turbine blades with thin blade airfoils.

Although this invention has been shown and described with respect to detailed embodiments thereof, it will be understood by those skilled in the art that various changes in form and detail thereof may be made without departing from the spirit and scope of the claimed invention. Accordingly, the preceding detailed description is merely exemplary in nature and is not intended to limit the invention or the application and uses of the invention. In particular, the described embodiments are not limited to use in conjunction with a particular type of gas turbine engine. For example, the described embodiments may be applied to stationary or motive gas turbine engines, or any variant thereof. Furthermore, there is no intention to be bound by any theory presented in any preceding section. It is also understood that the illustrations may include exaggerated dimensions and graphical representation to better illustrate the referenced items shown, and are not consider limiting unless expressly stated as such.

It will be understood that the benefits and advantages described above may relate to one embodiment or may relate to several embodiments. The embodiments are not limited to those that solve any or all of the stated problems or those that have any or all of the stated benefits and advantages.

What is claimed is:

1. A turbine blade for use in a gas turbine engine, the turbine blade comprising:
a base including
a root end; and
an airfoil comprising
a skin extending from the base and defining a first edge, a second edge opposite the first edge, a pressure side, and a lift side opposite the pressure side, and having a tip end opposite from the root end,
a base rib disposed within the airfoil and the base, extending from the base and into the airfoil, and having a base rib end disposed opposite from the base,
a center divider extending from adjacent the first edge towards the second edge, disposed between the base rib and the tip end,
a center rib disposed between the center divider and the second edge, extending from adjacent the center divider towards the tip end and extending from adjacent the center divider towards the root end, the center rib disposed between the root end and the tip end and at least partially between the base rib and the second edge, and having a center rib tip end disposed at the tip end of the center rib, and a center rib base end disposed opposite from the tip end,
a tip center rib extending from adjacent the second edge towards the first edge, disposed between the center rib and the tip end,
a tip rib extending from adjacent the tip center rib, distal to the second edge, towards the base, the tip rib disposed at least partially between the center rib and the first edge, disposed between the center divider and the tip end, and having a tip rib end disposed opposite from the tip end, and
a dividing rib extending from proximate an interface of the airfoil and the base, towards the tip end while between the first edge and the base rib, to between the tip rib and the first edge and between the tip end and the center divider, and having a dividing rib tip end disposed proximate and spaced from the tip end; and
a first channel beginning proximate the interface of the airfoil and the base, the first channel extending to the center divider while between the first edge and the dividing rib, the first channel further extends around the base rib tip, between the dividing rib and the center divider, and further to between the dividing rib and the center rib, the first channel further extends toward the root end while located between the dividing rib and the center rib, the first channel further extends around the center rib base end while between the center rib and the dividing rib, towards the tip end while between the center rib and the dividing rib, the first channel further extends towards the tip end while between the center rib and the dividing rib, the first channel further extends around the center rib tip end while between the center rib and dividing rib, towards the base while between the dividing rib and the center rib, the first channel further extends to the center divider while between the dividing rib and center rib, the first channel further extends around the tip rib end while between the dividing rib and the center divider, to between the dividing rib and the first edge, the first channel further extends towards the tip end, between the first edge and the dividing rib.

2. The turbine blade of claim 1, the turbine blade further comprising a second channel beginning proximate the interface of the airfoil and the base, the second channel extending from between the dividing rib and the base rib to the center divider, the second channel further extends around the base rib end, to between the base rib and the dividing rib, and further towards the base, the second channel further extends towards the root end while located between the base rib and the dividing rib, the second channel further extends around the center rib base end between the dividing rib and the root end, to between the dividing rib and the second edge, the second channel further extends to the tip center rib while between the dividing rib and the second edge, the second channel further extends around the center rib tip end while between the dividing rib and the tip center rib, to between the tip rib and the dividing rib, the second channel further extends towards the center divider while between the tip rib and dividing rib, the second channel further extends around the tip rib end while between the tip rib and the dividing rib, towards the tip end, the second channel further extends towards the tip end, between the dividing rib and the tip rib.

3. The turbine blade of claim 1, wherein the center rib and the dividing rib extend into the base.

4. The turbine blade of claim 1, the dividing rib further comprising
a dividing rib lower first edge portion extending from proximate to an interface of the airfoil and the base, towards the center divider while between the first edge and the base rib,
a dividing rib lower first edge transition portion extending from between the first edge and base rib, to between the base rib and the center divider, and further to between the base rib and the center rib,
a dividing rib lower middle portion extending from between the base rib and center rib towards the root end while located between the base rib and the center rib,
a dividing rib lower middle transition portion extending from between the base rib and the center rib, to between the center rib and the root end, and further to between the center rib and the second edge,
a dividing rib second edge portion extending from between the center rib and the second edge towards the tip center rib,
a dividing rib second edge transition portion extending from between the second edge and the center rib, to between the center rib and the tip center rib, and further to between the tip rib and the center rib,
a dividing rib upper middle portion extending from between the tip rib and center rib towards the center divider,
a dividing rib upper middle transition portion extending from between the tip rib and center rib, to between the tip rib and the center divider, and further to between the tip rib and the first edge, and
a dividing rib upper first edge portion extending from between the first edge and the tip rib towards the tip end.

5. The turbine blade of claim 1, wherein the base rib bends towards the first edge when located proximate to the interface of the airfoil and the base.

6. A turbine blade for use in a gas turbine engine, the turbine blade comprising:
a base including
a root end; and
an airfoil comprising a skin extending from the base and defining a leading edge, a trailing edge opposite from the leading edge, a pressure side, and a lift side opposite the lift side, and having
a tip end opposite from the root end,
a base rib disposed between leading edge and the trailing edge, extending from the base and towards the tip end,
a center divider extending from adjacent the leading edge towards the trailing edge, disposed between the base rib and the tip end,
a center rib disposed between the center divider and the trailing edge, extending from adjacent the center divider towards the tip end and extending from adjacent the center divider towards the root end, the center rib disposed between the root end and the tip end and at least partially between the base rib and the trailing edge,
a tip center rib extending from adjacent the trailing edge towards the leading edge, disposed between the center rib and the tip end,
a tip rib extending from adjacent the tip center rib towards the base, distal to the trailing edge, the tip rib disposed at least partially between the center rib and the leading edge, and disposed between the center divider and the tip end,
a tip wall extending from the leading edge towards the trailing edge, disposed proximate the tip end; and
a dividing rib including
a dividing rib lower first edge portion extending from proximate the interface of the airfoil and the base, towards the tip end while between the leading edge and the base rib,
a dividing rib lower first edge transition portion extending from between the leading edge and the base rib, to between the base rib and the center divider, and further to between the base rib and the center rib,
a dividing rib lower middle portion extending from between the base rib and center rib towards the root end while located between the base rib and the center rib,
a dividing rib lower middle transition portion extending from between the base rib and the center rib, to between the center rib and the root end, and further to between the center rib and the trailing edge,
a dividing rib second edge portion extending from between the center rib and the trailing edge towards the tip center rib,
a dividing rib second edge transition portion extending from between the trailing edge and the center rib, to between the center rib and the tip center rib, and further to between the tip rib and the center rib,
a dividing rib upper middle portion extending from between the tip rib and center rib towards the center divider,
a dividing rib upper middle transition portion extending from between the tip rib and center rib, to between the tip rib and the center divider, and further to between the tip rib and the leading edge, and
a dividing rib upper first edge portion extending from between the leading edge and the tip rib towards the tip wall, to between the center divider and tip wall.

7. The turbine blade of claim 6, wherein the dividing rib lower first edge transition extends from the dividing rib lower first edge portion, the dividing rib lower middle portion extends from the dividing rib lower first edge transition portion, the dividing rib lower middle transition portion extends from the dividing rib lower middle portion, the dividing rib second edge portion extends from the dividing rib lower middle transition portion, the dividing rib second edge transition portion extends from the dividing rib second edge portion, the dividing rib upper middle portion extends from the dividing rib second edge transition portion, the dividing rib upper middle transition portion extends from the dividing rib upper portion, the dividing rib upper first edge portion extends from the dividing rib upper middle transition portion.

8. The turbine blade of claim 7, the turbine blade further comprising
a first channel formed by the dividing rib, the skin, the leading edge, the center divider, and the center rib, and
a second channel formed by the dividing rib, the skin, the base rib, the trailing edge, the tip center rib, and the tip rib.

9. The turbine blade of claim 6, the center divider further comprising
a center divider transition extending from the center divider to the leading edge towards the trailing edge, that is wider adjacent the leading edge than opposite from the leading edge, and
a center rib transition disposed opposite from the center divider transition, extending from the center divider to the center rib towards the leading edge, that is wider adjacent the center rib than opposite the center rib.

10. The turbine blade of claim 6, the tip center rib further comprising
a tip center rib transition extending from the tip center rib to the trailing edge towards the leading edge, that is wider adjacent the trailing edge than opposite the trailing edge, and
a tip rib transition that is disposed opposite from the tip center rib transition that extends from the tip center rib towards the base.

11. The turbine blade of claim 8, the turbine blade further comprising
a main inlet disposed in the base and in flow communication with the first channel and the second channel, and
a secondary inlet disposed in the base and in flow communication with the second channel.

12. The turbine blade of claim 11, the turbine blade further comprising a metering plate blocking plate disposed radially inward of the main inlet, the metering plate having
a first metering orifice sized to provide a desired amount or flow of cooling air to the first channel, and
a second metering orifice sized to provide a desired amount or flow of cooling air to the second channel.

13. The turbine blade of claim 11, wherein the dividing rib lower first edge portion extends from main inlet to between the base rib and the leading edge.

14. A turbine blade for use in a gas turbine engine, the turbine blade comprising:
a base including
a root end; and
an airfoil comprising a skin extending from the base and defining a leading edge, a trailing edge opposite the leading edge, a pressure side, and a lift side opposite the pressure side, and having
a tip end opposite from the root end,
a base rib disposed between leading edge and the trailing edge, extending from the base and towards the tip end, having a base rib end disposed opposite from the base,
a center divider extending from adjacent the trailing edge towards the leading edge, disposed between the base rib and the tip end,
a center rib disposed between the center divider and the leading edge, extending from adjacent the center divider towards the tip end and extending from proximate the center divider towards the root end and at least partially between the base rib and the leading edge, and having
a center rib tip end disposed at the tip end of the center rib, and
a center rib base end disposed opposite from the tip end,
a tip center rib extending from adjacent the leading edge towards the trailing edge, disposed between the center rib and the tip end,
a tip rib extending from adjacent the tip center rib, distal to the leading edge, towards the base, the tip rib disposed at least partially between the center rib and the trailing edge, further disposed between the center divider and the tip end, and having a tip rib end disposed opposite from the tip end,
a dividing rib extending from proximate to an interface of the airfoil and the base, towards the tip end while between the trailing edge and the base rib, to between the tip rib and the trailing edge and between the tip end and the center divider, and having a dividing rib tip end disposed proximate and spaced from the tip end,
a second channel beginning proximate the interface of the airfoil and the base, the second channel extending from between the dividing rib and the base rib to the center divider, the second channel further extends around the base rib tip, to between the base rib and the dividing rib, and further towards the base, the second channel then further extends towards the root end while located between the base rib and the dividing rib, the second channel further extends around the center rib base end between the dividing rib and the root end, to between the dividing rib and the leading edge, the second channel further extends to the tip center rib while between the dividing rib and the leading edge, the second channel further extends around the center rib tip end while between the dividing rib and the tip center rib, to between the tip rib and the dividing rib, the second channel further extends towards the center divider while between the tip rib and dividing rib, the second channel further extends around the tip rib end while between the tip rib and the dividing rib, towards the tip end, the second channel further extends towards the tip end, between the dividing rib and the tip rib.

15. The turbine blade of claim 14, the turbine blade further comprising a first channel beginning proximate the interface of the airfoil and the base, the first channel extending to the center divider while between the trailing edge and the dividing rib, the first channel further extends around the base rib tip, between the dividing rib and the center divider, and further to between the dividing rib and the center rib, the first channel further extends toward the root end while located between the dividing rib and the center rib, the first channel further extends around the center rib base end while between the center rib and the dividing rib, towards the tip end while between the center rib and the dividing rib, the first channel further extends towards the tip end while between the center rib and the dividing rib, the first channel further extends around the center rib tip end while between the center rib and dividing rib, towards the base while between the dividing rib and the center rib, the first channel further extends to the center divider while between the dividing rib and center rib, the first channel further extends around the tip rib end while between the dividing rib and the center divider, to between the dividing rib and the trailing edge, the first channel further extends towards the tip end, between the trailing edge and the dividing rib, to between the dividing rib and the tip wall.

16. The turbine blade of claim 14, the dividing rib further comprising
a dividing rib lower first edge portion extending from proximate to an interface of the airfoil and the base towards the tip end, disposed between the trailing edge and the base rib,
a dividing rib lower first edge transition portion extending from the dividing rib lower first edge portion, to between the base rib and the center divider, and further to between the base rib and the center rib,
a dividing rib lower middle portion extending from the dividing rib lower first edge transition portion towards the root end while located between the base rib and the center rib, the dividing rib lower middle portion disposed between the center divider and the root end,
a dividing rib lower middle transition portion extending from the dividing rib lower middle portion, to between the center rib and the root end, and further to between the center rib and the leading edge,
a dividing rib second edge portion extending from the dividing rib lower middle transition portion towards the tip end while between the center rib and the leading edge, the dividing rib second edge portion disposed between the root end and the tip center rib,
a dividing rib second edge transition portion extending from the dividing rib second edge portion, to between the center rib and the tip center rib, and further to between the tip rib and the center rib,
a dividing rib upper middle portion extending from the dividing rib second edge transition portion towards the center divider while between the tip rib and center rib, the dividing rib upper middle portion disposed between the tip center rib and the center divider,
a dividing rib upper middle transition portion extending from the dividing rib upper middle portion, to between the tip rib and the center divider, and further to between the tip rib and the trailing edge, and
a dividing rib upper first edge portion extending from the dividing rib upper middle transition portion towards the tip end, between the trailing edge and the tip rib.

17. The turbine blade of claim 15, the turbine blade further comprising
a main inlet disposed in the base and in flow communication with the first channel and the second channel, and
a secondary inlet disposed in the base and in flow communication with the second channel.

18. The turbine blade of claim 17, the turbine blade further comprising a blocking plate disposed radially inward of the secondary inlet that can restrict cooling air from entering the secondary inlet.

19. The turbine blade of claim 14, wherein the turbine blade includes a tip opening that is defined by the space between the pressure side of the skin, the lift side of the skin, the tip center rib, and the trailing edge. The tip opening operable to allow for cooling air to escape the airfoil near the tip end.

20. The turbine blade of claim 16, wherein the dividing rib lower first edge portion extends from adjacent the root end to between the base rib and the trailing edge.
